(19) United States
(12) Patent Application Publication
(10) Pub. No.: US 2009/0313476 A1
(43) Pub. Date: Dec. 17, 2009

(54) METHOD AND APPARATUS FOR RESTRICTING USER ACCESS TO FIBER TO AN OPTIC NETWORK TERMINAL

(75) Inventors: David H. Liu, Herndon, VA (US); Guy M. Merritt, Purcellville, VA (US); Douglas A. Atkinson, Ashburn, VA (US); Fung-Chang Huang, Herndon, VA (US); Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/136,938

(22) Filed: Jun. 11, 2008

(51) Int. Cl. H04L 9/00; G06F 7/04

(52) U.S. Cl. 713/182; 726/7

(57) ABSTRACT

In traditional networks, a user provides an authorization to establish a connection for services with an Optical Network Terminal (ONT) and an Optical Line Terminal (OLT). The ONT becomes vulnerable to unauthorized users because the ONT restricts access at an Internet Protocol level. An embodiment of the present invention includes a system that restricts user access to services by causing a ranging fault to disable an ONT from communicating upstream with the OLT in an event the user fails to provide a valid ONT level user authorization. In an event the ONT is in a ranged state and the user fails to provide a valid service level authorization, the system causes a service level fault to restrict the ONT from granting user access to the user to services. Thus, unauthorized users are prevented access to the ONT and increased security is achieved.

### BACKGROUND OF THE INVENTION

Today, users receive access to services on Passive Optical Networks (PONs) with limited security. In particular, a user establishes a connection to a PON via an Optical Network Terminal (ONT), and the ONT provides services accessible via an Optical Line Termination (OLT). With an established connection, the ONT becomes vulnerable to unauthorized users.

### SUMMARY OF THE INVENTION

A method or corresponding apparatus in one embodiment of present invention restricts user access to services via an Optical Network Terminal (ONT). In one example embodiment, the ONT causes a ranging fault to disable itself from communicating upstream with an Optical Line Terminal (OLT) in a Passive Optical Network (PON) in an event the user fails to provide a valid, ONT level, user authorization entry. By causing the ranging fault, the ONT restricts a user's access to services. Further, the ONT, in an event it is in a ranged state but the user fails to provide a valid service level authorization entry, causes a service level fault to restrict the ONT from granting user access to the user to services.

A method or corresponding apparatus in another embodiment of the present invention of restricts user access to services via an Optical Network Terminal (ONT) in a network by applying a changing encryption key to communications. In an example embodiment, the system submits an encryption key in a state known to be recognized as a fault by a node receiving the encryption key. In this example embodiment, the system or node informs a user of restricted access to the node based on recognition of an encryption key fault by the node.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram depicting a Passive Optical Network (PON) restricting user access to services via an Optical Network Terminal (ONT) according to example embodiments of the invention;

FIG. 2 is a block diagram depicting an Optical Network Terminal (ONT) communicating upstream with an Optical Line Termination (OLT) according to example embodiments of the invention;

FIGS. 3A and 3B are block diagrams illustrating an exploded view of an Optical Network Terminal (ONT) according to example embodiments of the invention;

FIG. 4 is a flow diagram illustrating a procedure for causing a service level and ranging fault to restrict user access of an Optical Network Terminal (ONT) according to example embodiments of the invention;

FIG. 5 is a flow diagram illustrating a procedure for restricting user access to an Optical Network Terminal (ONT) due to an encryption key fault according to example embodiments of the invention;

FIG. 6 is a flow diagram illustrating a procedure restricting Optical Network Terminal (ONT) service to a user according to example embodiments of the invention; and

FIG. 7 is a block diagram depicting an exploded view of an Optical Network Terminal (ONT) using a submission module and a restriction module according to example embodiments of the invention.

### DETAILED DESCRIPTION OF THE INVENTION

A description of example embodiments of the invention follows.

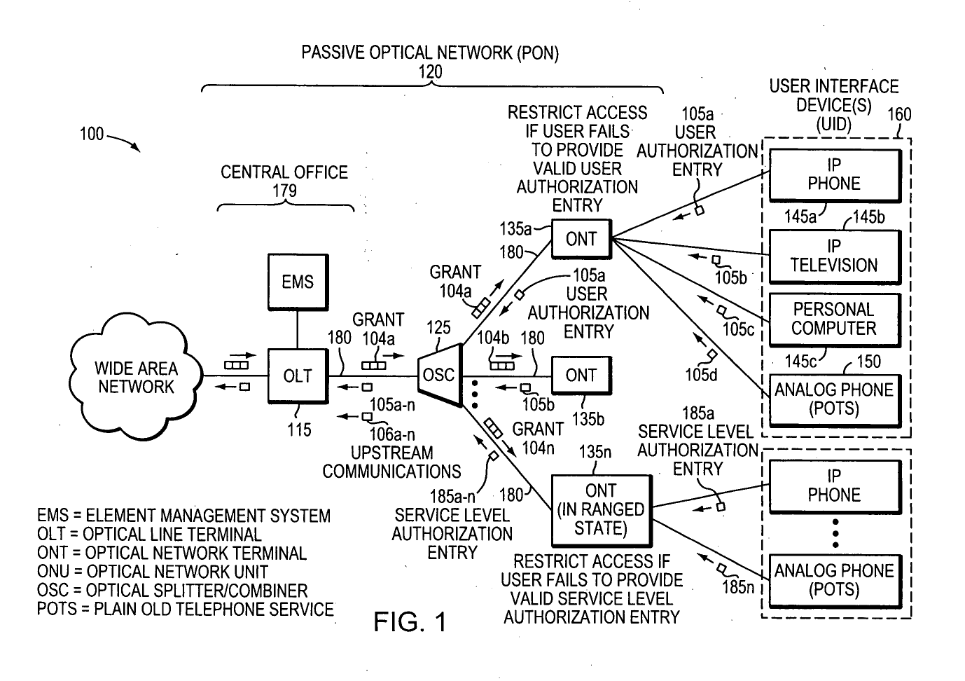

FIG. 1 is a block diagram depicting a Passive Optical Network (PON) 120. The PON 120 includes optical fiber cabling 180 to carry optical signals to and from one or more end users. Depending on where the PON 120 terminates, the PON 120 can be described as Fiber-To-The-Curb (FTTC), Fiber-To-The-Building (FTTB), or Fiber-To-The-Home (FTTH).

In an example embodiment, the PON 120 includes one or more Optical Line Terminal(s) (OLT) 110, typically located at a central office 179 maintained by a service provider, and one or more Optical Network Terminals (ONTs) 135a-n located at or near a premises of a user or customer. The ONTs 135a-n connect to one or more User Interface Devices (UID) 160, such as an IP phone 145a, IP television 145b, Personal Computer (PC) 145c, or Plain Old Telephone Service (POTS) 150. The UID 160 provides a user with an interface to one or more services via the corresponding ONT 135a-n, which sends requests from the UID 160 for services through an Optical Splitter/Combiner (OSC) 125 and ONT 135a-n to an OLTa-n 110.

In an example embodiment, a user of a UID 160, such as the IP phone 145a, attempts to authorize the IP phone 145a on the PON 120. In particular, the IP phone 145a sends a user authorization entry 105a to the ONT 135a. The ONT 135a, in turn, transmits the user authorization entry 105a upstream to the OLT 110. It is useful to note that communications between the OLT 110 and the ONT 135a use a downstream wavelength, such as 1490 nanometers (nm), and an upstream wavelength, such as 1310 nm. The user authorization entry 105a in the upstream communications, for example, can be transmitted from the ONT 135a to the OLT 110 at 1.244 Gbps. Other communications data rates known in the art may also be employed.

To ensure upstream communications between or among the ONTs 135a-n do not “collide,” a process known as ranging is performed prior to an ONT's communicating data, such as the user authorization entries 105a-n, in the upstream direction. Results of ranging the ONTs 135a-n by the OLT 110 include a determination of upstream timing offsets, which are provided to the ONTs 135a-n for use in determining how long to wait after receipt of a downstream grant 104a-n before transmitting an upstream communication (e.g., packet or series of packets, which may include the user authorization entries 105a-n). For example, following receipt of a grant 104a-n, the ONT 135a-n waits the prescribed upstream timing offset before transmitting respective user authorizations 105a-n or other upstream communications 106a-n upstream to the OLT 110.

Once a user is authorized and the ONT 135a ranges, an ONT identifier for the ONT 135a becomes active on the PON 120. Ranging may occur following a power outage, reset, software upgrade, and so forth. In some embodiments, a ranged state may be affected or effected during a user authorization procedure during which a UID 145a-n attempts to become an authorized device on the network to receive services via an ONT 135a-n. That is, the ONT 135a ranges to establish upstream communications capability on behalf of an authorized user of the UID 160 in some embodiments, and the ONT's ranged state may be affected depending on whether the UID 160 is found to be authorized to be on the network. In another embodiment, the ONT 135a may not allow itself to range unless it detects a UID 160 authorized to access services on the network, thus effecting the ONTs state of being ranged.

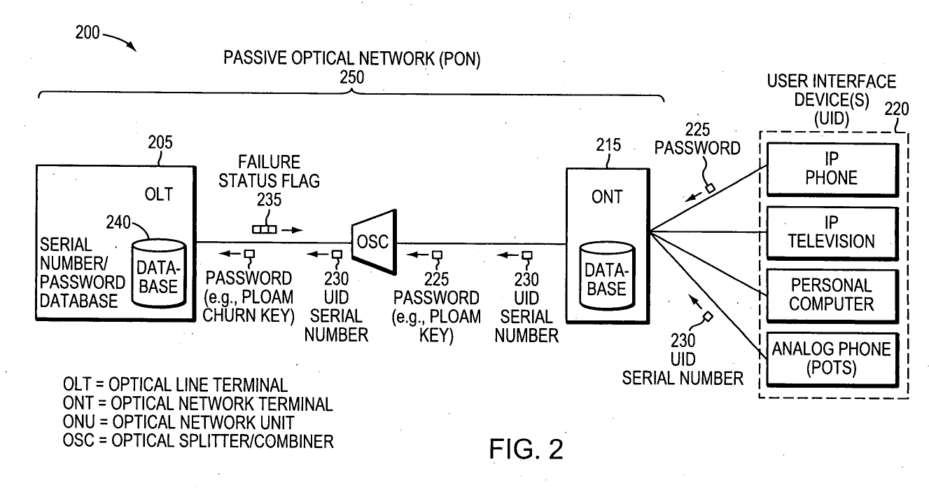

To establish user authorization, the ONT 135a can receive a password or passcode from the user of the UID 160 or from the UID itself through a handheld wireless or wireline device. A user, for example, may begin use of the IP phone 145a by lifting a receiver of the IP phone 145a (i.e., going “off-hook”). After lifting the receiver, the IP phone 145a may prompt the user to enter a password, and the IP phone 145a forwards the password, optionally along with a static serial number associated with the IP phone 145a, to the ONT 135a. It is useful to note that the password may be assigned or selected by the user or be a Physical Layer Operations, Administration, and Maintenance (PLOAM) password. If, in one embodiment, the serial number and password do not correspond to each other, as previously stored in a table (not shown) in the ONT, the user of the IP phone 145a is denied access to the PON 120 possibly by the ONT's changing its state of ranged to unranged, which disables its ability to communicate upstream to the OLT 110. Alternatively, the ONT 135a may transmit the password and, optionally, the serial number of the IP phone 145a to the OLT 110, in which case the OLT 110 may compare the password and serial number to information in its table (not shown) to determine whether the UID 160 is authorized to have access to the network. If the comparison fails, or succeeds in identifying a device not allowed to have access to the OLT or ONT, the OLT 110 may cause the ONT 135a to enter an unranged state, such as through not providing the ONT 135a with an equalization delay or other ranging parameter or reporting a failure status flag 235 (as shown in FIG. 2) or the like.

A user authorization password may be obtained in a variety of ways. In one embodiment, the ONT 135a uses Public Key Cryptography Standards (PKCS). For example, when a phone is off-hook, the ONT 135a may employ hardware security modules based solely on the phone's static serial number to authorize the phone and send the user authorization entry 105a upstream. In an alternative embodiment, the user takes the phone off-hook and a enters a personal security code (e.g., a password). The ONT 110 can then determine if the user entered the correct passcode and complete the ranging process.

Other examples of obtaining passwords include receiving passwords from a built-on keypad on the ONT 135a or UID 160 or from a security module providing a security token (e.g., a random number) which can be combined with a password for increased security (i.e., two passwords). The security token can be provided by a hardware device installed in the ONT 135a and used for initial authorization (e.g., before entering a user password). In one example embodiment, cryptographic options, such as a finger print scan, biometric, signature pads or unique user authorization, may be used as authorization input(s). These inputs may be provided by way of a machine-to-machine input or other suitable interface. It should be understood that other input techniques may be used, such as converting a Dual Tone Mult-Frequency (DTMF) signal to an ASCII code for processing or the like. It should also be understood that the user authorization process may apply to any number of UIDs 160, and authorization of the IP phone 145a is for illustrative purposes only.

Referring again to an example embodiment of the user authorization, once the user becomes authorized, the ONT 135a sends a signal to the OLT 110 at the head-end of the PON 120 to enable connectivity on the PON 120. Next, the ONT 135a ranges with the OLT 110, allowing the user to communicate using the IP phone 145a via the ONT 135a. It should be understood that the state of ranging can be used to provide connection level security, where a ranged state (as opposed to an unranged state) may result in the user having unrestricted access to the PON 120 via the ONT 135a. On the other hand, if the ONT 135a authorization fails, ranging between the ONT 135a and OLT 110 may terminate.

In one example embodiment, if a user fails to provide a valid ONT 135a level user authorization, the ONT 135a may cause a ranging fault to disable the ONT 135a from communicating upstream with the OLT 110. As a result, the ONT 135a restricts user access to services via the ONT 135a. The ONT 135a may also cause one of the following: disabling optical transmissions from the ONT 135a to the OLT 110, disabling the ONT 135a from responding to ranging requests, failing to provide the OLT 110 with a serial number of the ONT 135a during the ranging response, or providing an incorrect ONT 135a serial number to the OLT 110 in a ranging response. Moreover, the ONT 135a can cause a service level fault to restrict the ONT 135a from granting user access to services in an event the ONT 135a is in a ranged state and the user-entered password fails to provide a valid service level authorization entry 185a-n. One problem with using user-entered passwords is security risks relating to obtaining the passwords. One such way to increase security is to enable security for each service by using one or multiple respective encryption key(s), such as a churn key(s).

In one example embodiment, the ONT 135a generates a service level fault by causing a churn key fault between the ONT 135a and OLT 110. A churn key fault may be caused by at least one of the following: disabling churning a churn key, enabling the churning and not transmitting a churn key from the ONT 135a to the OLT 110, transmitting an erroneous churn key from the ONT 135a to the OLT 110, or generating churn keys out of phase from a correct phase of generating the churn keys. It should be understood that churn keys are presented above for illustrative purposes and any encryption or security key techniques known in the art can be employed.

As used herein, the term “ONT level” is used in connection with a ranged state of the ONT, where the ONT can be caused or self-cause itself to disable access to services by entering an unranged state. It should be noted that an ONT that is in an unranged state cannot communicate upstream on a shared fiber path but may continue to receive downstream services, which means, for example, that the ONT restricts the user's ability to join (e.g., change) and Internet Protocol television (IPTV) channel or access websites. Also, the term “service level” is used in connection with a UID's access to the ONT or encryption of downstream communications from the OLT to the ONT to enable/disable the UID's access to one or more services, which means, for example, all access to IPTV or websites may be restricted.

FIG. 2 shows a communications network 200 having an OLT 205 and an ONT 215 communicating in a PON 250. In this example embodiment, the ONT 215 receives a password or passcode 225 from a User Access Device (UID) 220 from a user entry. After the ONT 215 receives the password 225, the ONT 215 optionally forwards a serial number 230 associated with the UID 220 and the password 225 to the OLT 205. If the serial number 230 and the password 225 match information contained in a serial number/password database 240 in the OLT 205, the OLT 205 ranges the ONT 215, which allows the ONT 215 thereafter to send upstream communications and, hence, the UID 220 to establish a service level connection on the PON 250. In one embodiment, following ranging, the UID 220 can access other services available on the PON 250 without additional authorization/password entry.

If the UID 220 provides an invalid password 225, the ONT 215 may cause a ranging fault with the OLT 205 or a service level fault in the ONT 215, or both, to restrict user access to services.

The ONT 215 can cause a ranging fault by performing at least one of the following actions: disabling optical transmissions from the ONT 215 to the OLT 205, disabling the ONT 215 from responding to ranging requests from the OLT 205, failing to provide an ONT 215 serial number 230 in a ranging response, or providing an incorrect ONT 215 serial number in the ranging response. Since an authorized user has access to services on the PON 250 and the ONT 215, the ONT 215 can prevent an unauthorized UID 220 from accessing the PON 250, which increases security.

In one embodiment, the ONT 215 may also restrict an authorized UID 220 by causing a service level fault. A churn key is an encryption key that changes over time, such as once per minute, and may be randomly generated by the ONT 215 and used by the OLT 205 to encrypt downstream communications to the ONT 215 to increase security for downstream communications to the ONT 215. In some embodiments, the ONT 215 may intentionally fail to update the churn key sent to the OLT 205 to force an invalid key, thereby causing a mismatch between the encryption key used by the OLT 205 to encrypt downstream communications and the decryption key used by the ONT 215 to decrypt the downstream communications. Thus, in a state of service level fault of the ONT 215, the UID 220 will not be able to receive communications via the ONT 215 because the ONT cannot decrypt the downstream communications to learn of which device is the destination, for example, or which port the ONT is to direct the communicating as another example. In other embodiments, the ONT 215 may generate a faulty encryption key to forward to the OLT 205. The ONT 215 also may submit the encryption key at a rate other than the OLT 205 expects. In one embodiment, the ONT disables service for multiple inputs of invalid service level authorization inputs and reports an indicator of the disabled service. In this embodiment, the ONT 215 may obtain a valid service level authorization entry by reading a human-to-machine input or machine-to-machine input and comparing the input to known, valid, ONT level, user authorizations. In this way, the ONT 215 restricts services and/or access to the PON 250.

In operation, the ONT 215 may grant or restrict user access to services by not causing or causing a churn key fault, respectively. Further, the ONT 215, during a service level fault, may also restrict access by providing less than a full set of services or providing a lower rate of services, allowing for some use. In this way, the ONT 215 restricts unauthorized devices, such as UID 220, from accessing the PON 250.

Other techniques for restricting access of the UID 220 to the PON 250 can also be employed. For example, in an event of an incorrect authorization attempt by the UID 220, the ONT 215 may submit an encryption key in a faulty state to the OLT 205 and inform the UID 220 of the restricted access. In one embodiment, the ONT 215 may submit the encryption key in a non-value or malformed state, resulting in the OLT 205 restricting access. Thus, embodiments of the present invention may restrict the UID 220 from accessing the PON 250 in a number of ways.

It should be understood that embodiments of the present invention may be useful for many security applications, such as government agencies or other organizations that employ a high level of security protection. Moreover, an operator of the PON 250 can apply the security in different levels, such as on a service level or ONT access level.

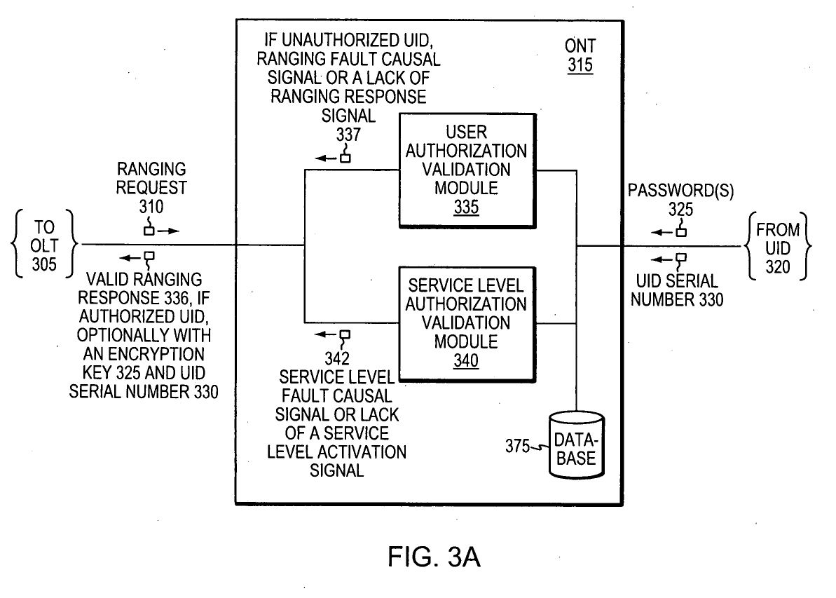

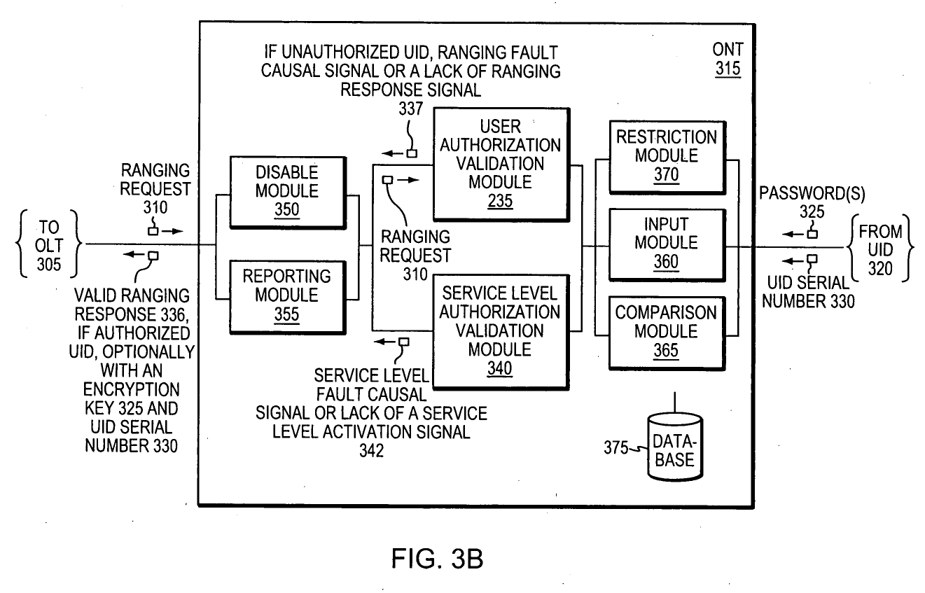

FIG. 3A shows a communications network communicating between an ONT 315 and an OLT 305. In operation, the ONT 315 receives a password 325 from User Access Device (UID) 320. If the password 325 is incorrect, a user authorization validation module 335 causes a ranging fault to disable communications between the ONT 315 and the OLT 305 by sending a ranging fault causal signal or lack of a ranging response signal 337 to the OLT 305. To restrict access to the ONT 315 at a service level, a service level authorization validation module 340 causes a service level fault to restrict access to services by the UID 320, which may be in a form of a service level fault causal signal or lack of a service level activation signal 342. The user authorization validation module 335 and service level authorization validation module 340 are capable of using any technique described above for causing faults or otherwise disabling service accessible by the UID 320.

In one embodiment, operation of the ONT 315 with the modules 335, 340 may work in the following manner. If the user authorization validation module 335 determines the UID 320 is authorized, the ONT 315 responds to a ranging request 310 with a valid ranging response. The ONT 315 sends a ranging response 336, in some embodiments, with the encryption key 325 and UID serial number 330. Once ranging successfully completes, the UID 320 is granted access to the PON and respective services via the ONT 315. In this embodiment, after ranging is complete, access is granted either for a particular service or all services at the ONT 315 level. It should be understood that, if the user authorization validation module 335 determines the UID 320 is unauthorized, the ONT 315 sends a ranging fault causal signal or lack of a ranging response signal 337 to cause a ranging fault, thereby disabling the ONT 315 from transmitting upstream communications, which restricts user access to certain services.

Continuing to describe the operation of the ONT 315, at the service level, the ONT 315 ranges, but certain services may be restricted. Service can be granted in some embodiments on a service-by-service basis, such as if the user of the UID 320 passes authorization criteria for each service. At the ONT 315 level, the ONT 315 ranges and synchronizes with the OLT 305 after the user is authorized. Without authorization, services, such as data, voice, or video, may be denied. It should be understood that the user authorization validation module 335 and service level authorization validation module 340 may be located within the ONT 315, outside the ONT 315, or some combination thereof. Further, the modules 335, 340 may communicate with each other or be integrated in a single processor, for example, and have access to each other's parameters, outputs, or other data or operational information.

FIG. 3B illustrates an alternative example embodiment of the communications network illustrated in FIG.3A. In this embodiment, the OLT 305 may also include a disable module 350, reporting module 355, input module 360, comparison module 365, and restriction module 370. The disable module 350 may be configured to disable optical transmissions from the ONT 315 to the OLT 305. For example, the disable module 350 may prevent the ONT 315 from responding to a ranging request 337, or may fail to provide an ONT serial number in a ranging response or may provide an incorrect ONT serial number in a ranging response 337. The disable module 350 may also disable service for multiple inputs of invalid, service level, and authorization entries. The reporting module 355 may report the disabled service, disable mechanism, or other status information.

The input module 360 may include a human-to-machine interface such as a keyboard or touch screen (not shown) or a machine-to-machine interface configured to obtain a valid, ONT level user authorization entry from a UID 320. The obtained, ONT level user authorization entry may be provided to the comparison module 365 where it may be compared to known, valid, ONT level user authorization codes. The known, valid, ONT level user authorization codes may be stored in a database 375 located in the ONT 315, the OLT 305, or other external location.

The restriction module 370 may restrict access to the ONT in the event a ranging fault 337 or service level fault 342 occurs. For example, upstream communications may be restricted, or less than a full set of services may be provided, if the fault is a ranging fault. If the fault is a service level fault, a subset of services may be provided. Note that although the modules 350, 355, 360, 365, and 370 are shown as separate modules they may be combined into one or more modules. For example, the comparison module 365 may be combined with the service level authorization validation module 340. Furthermore, the modules 350, 355, 360, 365, and 370 may be located, individually or in combination, on the ONT 315, OLT 305, or UID 320.

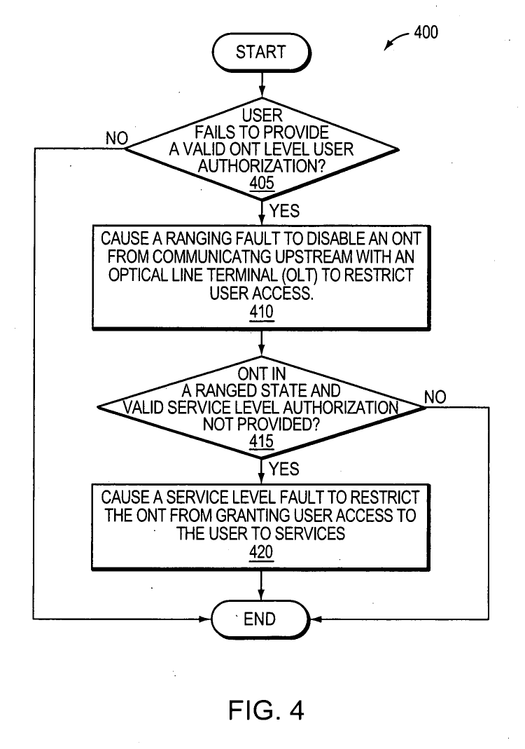

FIG. 4 is a flow diagram illustrating a procedure 400 causing a service level fault or ranging fault to restrict user access to a network via an Optical Network Terminal (ONT). After beginning, the procedure 400 restricts user access to services in an event the user fails to provide a valid ONT level user authorization (405). The procedure 400 may responsively cause a ranging fault (410), which thereafter disables the ONT from communicating upstream with an Optical Line Terminal (OLT). By causing the ranging fault, the system restricts a user's access to services via the ONT. Further, the procedure 400, in an event the ONT is in a ranged state but the user fails to provide a valid service level authorization entry (415), causes a service level fault (420) to restrict the ONT from granting user access to the user to services.

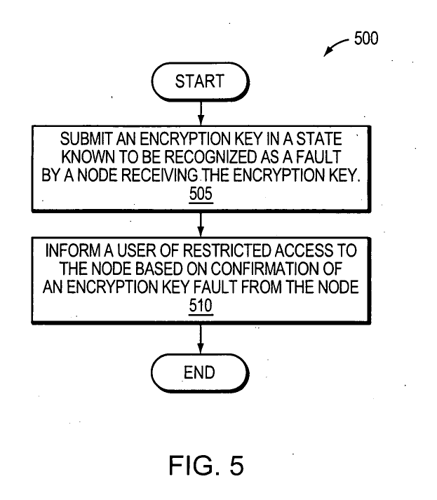

FIG. 5 is a flow diagram illustrating restricting user access to an Optical Network Terminal (ONT) due to an encryption key fault. After beginning, the procedure 500 submits (505) an encryption key in a state known to be recognized as a fault by a node receiving the encryption key. For example, the OLT may check the encryption key to determine whether it meets valid criteria. Alternatively, or in addition, the ONT may detect an invalid encryption key due to an error in decrypting a downstream communication because of a difference in the encryption key the ONT knows or assumes is valid and the encryption key used by the OLT, as received from the ONT, to encrypt the downstream communications to the ONT. The encryption key may be a churn key, Advanced Encryption Standard (AES) key, or other suitable security key. After submitting the key, the procedure 500 informs (510) a user of restricted access to the node based on confirmation of an encryption key fault from the node. In this way, the procedure 500 increases security against unauthorized users or UIDs.

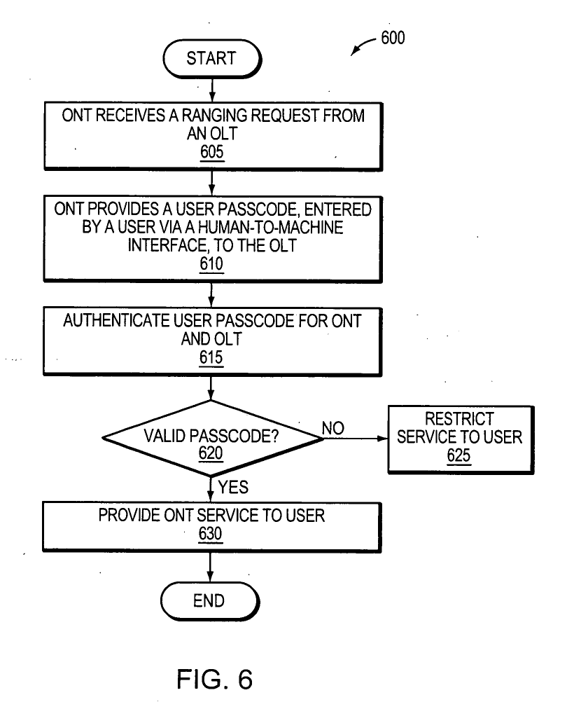

FIG. 6 is a flow diagram for a procedure 600 providing or restricting Optical Network Terminal (ONT) service to a user. After beginning, the ONT receives a ranging request from an OLT (605). The ONT provides (610) a user passcode or password, which may be entered by a user via a human-to-machine interface, to the OLT. For example, a user may enter an authorization passcode, via a human-to-machine interface, into a UID, and the UID forwards the passcode to the ONT. The procedure 600 authorizes a user, using the passcode, and the ONT forwards passcode to the OLT for authorization. The procedure 600 authorizes the user passcode (615) and determines if the passcode is valid (620). If the passcode is valid, the procedure 600 provides ONT service to the user (630). If the passcode is invalid, the procedure 600 restricts access to the user (625). Through this procedure 600, two levels of security, namely at an ONT level and service level, are provided.

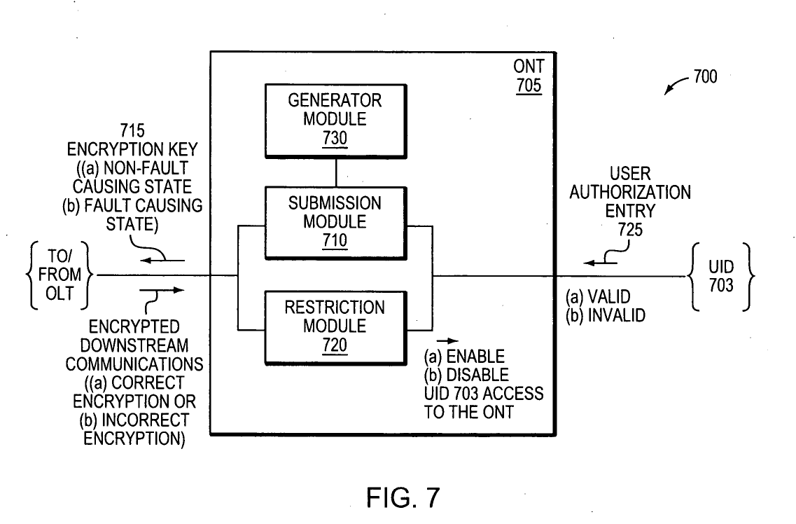

FIG. 7 is a block diagram of an Optical Network Terminal (ONT) 705 having a submission module 710 and a restriction module 720 according an example embodiment of the invention. The ONT 705 receives a user authorization entry 725 from a UID 703, which may be (a) valid or (b) invalid. If the user authorization entry 725 is invalid, case (b), the ONT 705, using the submission module 710 and the restriction module 720, restricts the UID 703 from gaining access to an OLT (not shown). Specifically, the submission module 710, upon identifying receipt of an invalid user authorization entry 725, submits an encryption key 715 in a state known to cause a fault in a later decryption of downstream communications by the ONT 705 of the communications encrypted by the OLT with the encryption key in a fault causing state, case (b). Next, the restriction module 720 restricts user access to the ONT 705 based on the encryption key 715 state. In this way, the ONT 705 increases security.

It should be understood that the encryption key may be or include any security key, as mentioned above or otherwise known. It should be further understood that the feature of the faulty encryption key can be generated by an encryption key generator module 730. Moreover, a variety of encryption keys, such as a churn key and user inputs of keys, are applicable. Additionally the submission module 710 and restriction module 720 are illustrated with respect to the service level authorization procedure. These or other modules may be applied to ONT level authorization procedure, too.

While this invention has been particularly shown and described with references to example embodiments thereof, it will be understood by those skilled in the art that various changes in form and details may be made therein without departing from the scope of the invention encompassed by the appended claims.

For example, any of the flow diagrams described herein may be modified or arranged in any manner to support operation in various network configurations. The flow diagrams may include more or fewer blocks, combined or separated blocks, or employ alternative flow arrangements or the like. The flow diagrams may also be implemented in the form of hardware, firmware, or software. If implemented in software, the software may be written in any suitable code in accordance with the example embodiments herein, equivalents thereof, or other suitable embodiments. The software may be stored in any form of computer readable medium and be capable of being loaded and executed by a general purpose or application specific processor suitable to perform the example embodiments described herein, equivalents thereof, or other suitable embodiments.

Although examples are shown in the form of software solutions, increased security may also be achieved using a hardware security “add-on” module to an ONT or may also be incorporated into the ONT itself as shown in FIG. 3. For example, some ONT deployments are done without a battery used for battery backup, which is activated in an event of a loss of primary power. Such deployments include deployments in facilities where batteries are not allowed or wanted and permant deployments within walls or other non-accessible spaces. In either example case, a hardware security module may be installed into a battery compartment, in ONTs having such a compartment, or connect to terminals where battery leads might be externally connected, of course having appropriate circuitry within the ONT also connected to the terminals to enable the security module to operate.

What is claimed is:

1. A method of restricting user access to services via an Optical Network Terminal (ONT), the method comprising:
causing a ranging fault to disable an ONT from communicating upstream with an Optical Line Terminal (OLT) in a manner restricting a user's access to services via the ONT in an event the user fails to provide a valid, ONT level, user authorization entry; and
causing a service level fault to restrict the ONT from granting user access to the user to services in an event the ONT is in a ranged state but the user fails to provide a valid, service level, authorization entry.

2. The method of claim 1 wherein causing a ranging fault further includes at least one of the following: disabling optical transmissions from the ONT to the OLT, disabling the ONT from responding to a ranging request, failing to provide an ONT serial number in a ranging response, or providing an incorrect ONT serial number in a ranging response.

3. The method of claim 1 further comprising obtaining the valid ONT level user authorization entry by:
reading a human-to-machine input or machine-to-machine input; and
comparing the input to known, valid, ONT level, user authorization codes.

4. The method of claim 1 wherein causing a service level fault includes:
determining whether a service level authorization entry is valid or invalid;
disabling service in an event the service level authorization entry is invalid by causing the service level fault; and
reporting an indicator of the disabled service.

5. The method of claim 1 wherein causing a service level fault includes causing a churn key fault between the ONT and OLT.

6. The method of claim 5 wherein causing the churn key fault includes performing at least one of the following: disabling churning of a churn key, enabling the churning and not transmitting a churn key from the ONT to the OLT, transmitting an erroneous churn key from the ONT to the OLT, or generating churn keys out of phase from a correct phase of generating the churn keys.

7. The method of claim 1 further comprising obtaining a valid service level authorization entry by: reading a human-to-machine input or machine-to-machine input; and
comparing the entry to known, valid, ONT level, user authorizations; and
causing the service level fault in an event the entry does not correspond to a known, valid, ONT level, user authorization.

8. The method of claim 1 further comprising:
restricting access, in the event of a ranging fault or service level fault, by providing no support of upstream communications if the fault is a ranging fault or less than a full set of services or providing a lower rate of services if the fault is a service level fault.

9. The method of claim 1 wherein causing a service level fault includes disabling service due to multiple attempts by a user to provide a valid service level authentication entry and reporting an indicating of same.

10. An apparatus to restrict user access to services via an Optical Network Terminal (ONT), comprising:
a user authorization validation module configured to cause a ranging fault to disable the ONT from communicating upstream with an Optical Line Terminal (OLT) in a manner restricting a user's access to services via the ONT in an event the user fails to provide a valid, ONT level, user authorization entry; and
a service level authorization validation module configured to cause a service level fault to restrict the ONT from granting access to the user to services in an event the ONT is in a ranged state but the user fails to provide a valid, service level, authorization entry.

11. The apparatus of claim 10 further comprising:
a disable module configured to disable optical transmissions from the ONT to the OLT, disable the ONT from responding to a ranging request, fail to provide an ONT serial number in a ranging response, or provide an incorrect ONT serial number in a ranging response.

12. The apparatus of claim 10 further comprising:
an input module configured to obtain the valid, ONT level user authorization entry via a human-to-machine interface or a machine-to-machine interface; and
a comparison module to compare the entry to known, valid, ONT level, user authorization codes.

13. The apparatus of claim 10 wherein further comprises:
a disable module to disable service for multiple inputs of invalid, service level, authorization entries; and
a reporting module to report the disabled service.

14. The apparatus of claim 10 wherein the service level authorization validation module is configured to cause the service level fault by causing a churn key fault between the ONT and OLT.

15. The apparatus of claim 14 wherein the service level authorization module is configured to cause the churn key fault is as a result by disabling churning of a churn key, enabling churning but disabling transmission of the churn key, transmitting an erroneous churn key from the ONT to the OLT, or generating a churn key out of phase from a correct phase of generated churn keys.

16. The apparatus of claim 10 wherein the user authorization validation module is further configured to obtain a service level, authorization entry via a human-to-machine input module or a machine-to-machine input module, and further includes a comparison module to compare the service level, authorization entry to known valid ONT level user authorization codes.

17. The apparatus of claim 10 further comprising:
a restriction module to restrict access to the ONT, in the event of a ranging fault or service level fault, by providing no support of upstream communications if the fault is a ranging fault or less than a full set of services for the ranging fault or providing a lower rate of services in the event of the service level fault.

18. A method of restricting user access to services via an Optical Network Terminal (ONT) in a network applying a changing encryption key to communications, the method comprising:
submitting an encryption key in a state known to be recognized as a fault by a node receiving the encryption key; and
informing a user of restricted access to the node based on recognition of an encryption key fault by the node.

19. The method of claim 18 wherein the encryption key is a churn key.

20. The method of claim 18 wherein the encryption key is a churn key and further comprising failing to update the churn key relative to a previous churn key.

21. The method of claim 18 wherein submitting the encryption key includes submitting the encryption key in a non-value state or in a malformed state.

22. The method of claim 18 further comprising generating a faulty encryption key to be submitted to the node receiving the encryption key.

23. The method of claim 18 wherein submitting the encryption key includes submitting the encryption key at a rate other than an expected rate by the node receiving the encryption key.

24. The method of claim 18 wherein submitting the encryption key includes submitting the encryption key responsive to a failure of a user to provide a valid user authorization entry.

25. The method of claim 24 wherein the valid user authorization entry is a user biometric, password, or other unique authorization entry.

26. The method of claim 18 further comprising:
generating an encryption key known to be a mismatch from a value of the encryption key expected by the node receiving the encryption key.

27. An apparatus to restrict user access to services via an Optical Network Terminal (ONT) in a network applying a changing encryption key to communications, comprising:
a submission module configured to submit an encryption key in a state known to be recognized as a fault by a node receiving the encryption key; and
a restriction module configured to restrict user access to the node based on recognition of an encryption key fault by the node.

28. The apparatus of claim 27 wherein the encryption key is a churn key.

29. The apparatus of claim 27 wherein the encryption key is a churn key and the restriction module is further configured not to update the churn key relative to a previous churn key.

30. The apparatus of claim 27 wherein the encryption key is in a non-value or malformed state.

31. The apparatus of claim 27 further comprising a generator module to generate a faulty encryption key to be submitted to the node receiving the encryption key.

32. The apparatus of claim 27 wherein the submission module is further configured to submit the encryption key at a rate other than an expected rate by the node receiving the encryption key.

33. The apparatus of claim 27 wherein the submission module is further configured to submit the encryption key responsive to a failure of a user to provide a valid user authorization entry.

34. The apparatus of claim 33 wherein the valid user authorization entry is a user biometric, password, or other unique authorization entry.

35. The apparatus of claim 27 further comprising a generator module to generate an encryption key known to be a mismatch from a value of the encryption key expected by the node receiving the encryption key.
